(19) United States
(12) Patent Application Publication
(10) Pub. No.: US 2013/0159275 A1
(43) Pub. Date: Jun. 20, 2013

(54) INFORMATION SEARCHING SYSTEM AND METHOD

(71) Applicant: HONG-YU YANG, Shenzhen City (CN)

(72) Inventor: HONG-YU YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/572,713

(22) Filed: Aug. 13, 2012

(30) Foreign Application Priority Data
Dec. 14, 2011 (CN) 201110418140.7

(51) Int. Cl. G06F 17/30

(52) U.S. Cl. 707/706; 707/E17.108

(57) ABSTRACT

An information searching system and a searching method adapted for the system are provided. The system is utilized for searching for web pages with reference to information input by a user and removing repetitive web pages. The method includes steps: inputting a keyword on a web search engine in response to user input; searching for a number of pieces of summary information with regard to the keyword; acquiring a network address from each piece of information, acquiring each web page corresponding to the acquired network address and determining whether text information of each web page comprises another network address; and if the text information of one web page comprises another network address, removing a piece of the summary information corresponding to the web page from the number of pieces of the summary information.

### BACKGROUND

1. Technical Field

The disclosure relates to searching technology and, more particularly, to an information searching system and a searching method adapted for the system.

2. Description of Related Art

When a user searches for web pages on a search engine, very often than not, a large number of web pages will be returned as a search result, with a lot of them being redundant in contents, which results in wasting a lot of time browsing through the redundant web pages.

Therefore, what is needed is an information searching system to overcome the described shortcoming.

### BRIEF DESCRIPTION OF THE DRAWINGS

FIG. 1 is a block diagram of an information searching system in accordance with an exemplary embodiment.

FIG. 2 is a flowchart of searching information method adapted for the system of FIG. 1.

### DETAILED DESCRIPTION

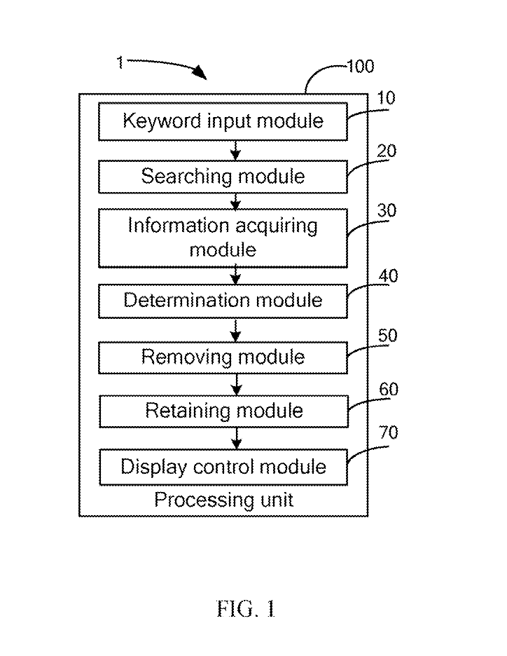

FIG. 1 is a block diagram of an information searching system in accordance with an exemplary embodiment. The information searching system (hereinafter “system”) 1 is utilized for searching for web pages according to information input by a user and removing repetitive web pages from the searched web pages, therefore saving a lot of time. The information input by a user may be a keyword. The system 1 is applied in an electronic device as a client or in a server.

The system 1 includes a processing unit 100 which controls the system 1 to search web pages and remove repetitive web pages from the searched web pages. The processing unit 100 includes a keyword input module 10, a searching module 20, an information acquiring module 30, a determination module 40, a removing module 50, and a retaining module 60.

The keyword input module 10 inputs a keyword to a web search engine in response to user input. For example, the keyword input module 10 inputs a keyword “central park” to the Google search engine. The searching module 20 searches for a number of pieces of summary information with regard to the keyword on a searching interface after inputting the keyword.

In the embodiment, each piece of information includes a network address and a description. The network address is represented by a Uniform Resource Locator (URL) and is used to link to a web page. A user can look at contents of the web page to know information about the central park. For example, the network address is a format of www.abc.com. Content of each web page corresponding to the network address may include another network address, text, image, audio, video, or any combination of all. The another network address represents where a part of the content of the web page is cited and is used to link to the cited web page. The information acquiring module 30 acquires the network address from each piece of the summary information and acquires each web page corresponding to the acquired network address.

The determination module 40 determines whether text information of each web page includes another network address, for example, determining whether one web page includes a symbol “<a href>”. If the text information of one web page includes another network address, that means that the content of the web page is cited from another web page corresponding to the another network address, the removing module 50 removes such web page from the searched web pages and removes a piece of the summary information corresponding to the web page from the pieces of the summary information. Therefore, the web pages whose contents include the another network address are removed and only the web page linked to the another network address is retained.

After removing the piece of information, the determination module 40 further compares two of retained pieces of the summary at a time and determines whether a similarity of any two pieces of the summary information is greater than a preset value. The more the number of the same words of the text information of the two web pages is, the greater the similarity of the two pieces of the summary information is.

If the similarity of any two pieces of the summary information is greater than the preset value, it is regarded that there is one repetitive web page between the two web pages, the retaining module 60 further acquires a web page corresponding to one of the two pieces of the summary information whose contents for similarity comparison are greater or whose creation time is earlier than the other web page and retains the one of the two pieces of the summary information corresponding to the acquired web page, and the removing module 50 further removes other piece of the summary information, namely the repetitive web page. If the similarity of any two pieces of the summary information is less than the preset value, the retaining module 60 retains the two pieces of the summary information. The processing unit 100 further includes a display control module 70, and the display control module 70 displays the retained pieces of the summary information.

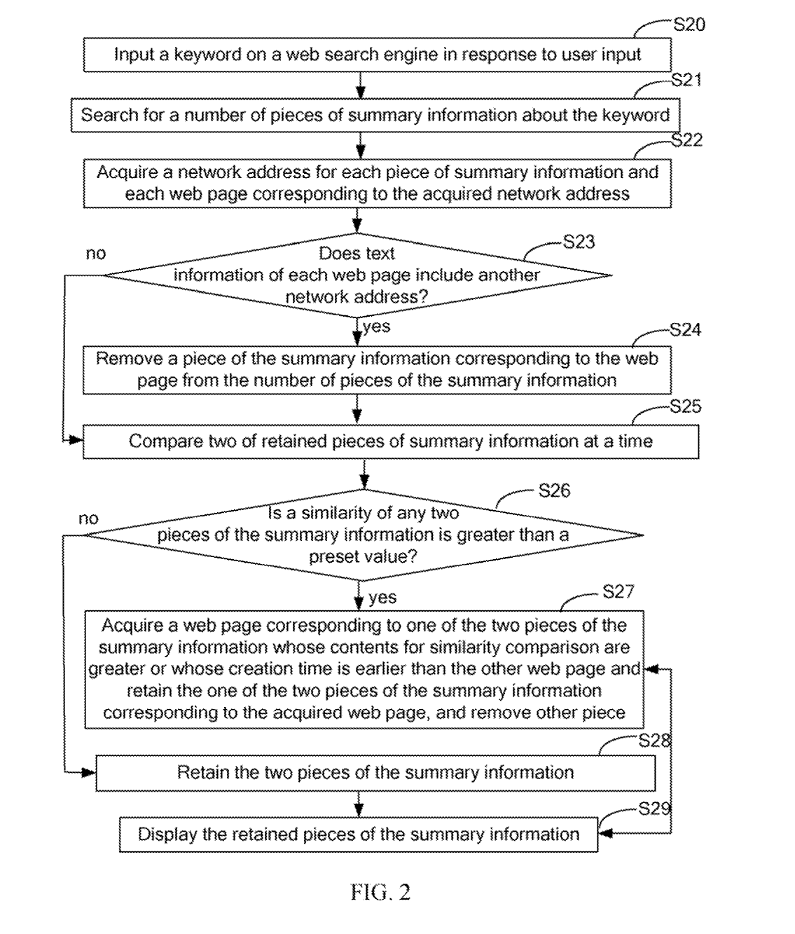

FIG. 2 is a flowchart of searching information method adapted for the system of FIG. 1. In step S20, the keyword input module 10 inputs a keyword on a web search engine in response to user input. In step S21, the searching module 20 searches for a number of pieces of summary information with regard to the keyword on a searching interface. In step S22, the information acquiring module 30 acquires the network address from each piece of the summary information and acquires each web page corresponding to the acquired network address.

In step S23, the determination module 40 determines whether text information of each web page includes another network address. In step S24, if the text information of one web page includes another network address, the removing module 50 removes such web page from the searched web pages and removes a piece of the summary information corresponding to the web page from the number of pieces of the summary information. If the text information of one web page does not include another network address, the step goes to S25.

In step S25, the information acquiring module 30 further compares two of retained pieces of summary information at a time. In step S26, the information acquiring module 30 further determines whether a similarity of any two pieces of the summary information is greater than a preset value.

In step S27, if the similarity of the text information of the two web pages is greater than the preset value, the retaining module 60 further acquires a web page corresponding to one of the two pieces of the summary information whose contents for similarity comparison are greater or whose creation time is earlier than the other web page and retains the one of the two pieces of the summary information corresponding to the acquired web page. In addition, the removing module 50 further removes other piece of the summary information.

In step S28, if the similarity of any two pieces of the summary information is less than the preset value, the retaining module 60 further retains the two pieces of the summary information corresponding to the two web pages. In step S29, the display control module 70 displays the retained pieces of the summary information.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An information searching system comprising:
a processing unit comprising:
a keyword input module to input a keyword on a web search engine in response to user input;
a searching module to search for a number of pieces of summary information with regard to the keyword on a searching interface, wherein each piece of information comprises a network address which is used to link to a web page;
an information acquiring module to acquire a network address from each piece of the summary information and acquire each web page corresponding to the acquired network address;
a determination module to determine whether text information of each web page comprises another network address; and
a removing module to remove a piece of the summary information corresponding to one web page from the number of pieces of the summary information when the text information of the web page comprises another network address.

2. The information searching system as recited in claim 1, wherein the processing unit further comprises a display control module, and the display control module is configured to display retained pieces of the summary information.

3. The information searching system as recited in claim 1, wherein the determination module is further configured to compare two of retained pieces of the summary information at a time and determine whether a similarity of any two pieces of the summary information is greater than a preset value; and
when the similarity of any two pieces of the summary information is greater than the preset value, the retaining module is further configured to acquire a web page corresponding to one of the two pieces of the summary information whose contents for similarity comparison are greater or acquiring the web page corresponding to one of the two pieces of the summary information whose creation time is earlier than the other web page and retain the one of the two pieces of the summary information corresponding to the acquired web page and the removing module is further configured to remove other piece of the summary information.

4. The information searching system as recited in claim 3, wherein the processing unit further comprises a display control module, and the display control module is configured to display the further retained pieces of the summary information.

5. The information searching system as recited in claim 1, wherein the system is applied in an electronic device as a client.

6. The information searching system as recited in claim 1, wherein the system is applied in a server.

7. An information searching method comprising:
inputting a keyword on a web search engine in response to user input;
searching for a number of pieces of summary information with regard to the keyword on a searching interface;
acquiring a network address from each piece of summary information;
acquiring each web page corresponding to the acquired network address and determining whether text information of each web page comprises another network address; and
if the text information of any one of web pages comprises another network address, removing a piece of the summary information corresponding to the web page from the number of pieces of the summary information.

8. The information searching method as recited in claim 7, further comprising:
displaying retained pieces of the summary information.

9. The information searching method as recited in claim 7, further comprising:
comparing two of retained pieces of summary information at a time, and determining whether a similarity of any two pieces of the summary information is greater than a preset value; and
if the similarity of any two pieces of the summary information is greater than the preset value, acquiring a web page corresponding to one of the two pieces of the summary information whose contents for similarity comparison are greater or acquiring the web page corresponding to one of the two pieces of the summary information whose creation time is earlier than the other web page, and retaining the one of the two pieces of the summary information corresponding to the acquired web page and removing other piece of the summary information.

10. The information searching method as recited in claim 9, further comprising:
displaying the further retained pieces of the summary information.
